(19) United States
(12) Patent Application Publication
(10) Pub. No.: US 2026/0018922 A1
(43) Pub. Date: Jan. 15, 2026

(54) MOBILE BATTERY AND CHARGER FOR CONTAINER HANDLING EQUIPMENT

(71) Applicant: TMEIC Corporation Americas, Salem, VA (US)

(72) Inventors: Paul S. Bixel, Bedford, VA (US); Marcelo A. Lara, Gibsonia, PA (US)

(21) Appl. No.: 19/265,971

(22) Filed: Jul. 10, 2025

Related U.S. Application Data
(60) Provisional application No. 63/669,374, filed on Jul. 10, 2024.

(51) Int. Cl. H02J 7/34; H01M 10/613; H02J 7/00

(52) U.S. Cl. CPC H02J 7/342; H01M 10/613; H02J 7/00034; H02J 7/0013; H02J 7/0048; H02J 7/0071; H01M 2220/20

(57) ABSTRACT

Systems and methods for charging batteries of electric container handling equipment at container terminals comprising mobile batteries and chargers that can be transported to a location near the container handling equipment. The mobile batteries and chargers are configured for energy storage and capable of being recharged at one or more charging stations. Multiple mobile batteries and chargers can be included in the system and/or methods, and one or more or each mobile battery and charger can be configured to recharge one or more or several pieces of container handling equipment before the mobile battery and charger travels to the charging station to recharge. Included are systems for managing shipping equipment in a container terminal comprising one or more mobile battery and charger configured to deliver at least about 100 KW of power to any equipment configured for loading, unloading, and/or moving shipping containers, such as a shipping container crane.

### CROSS-REFERENCE TO RELATED APPLICATIONS

This application relies on the disclosure of and claims priority to and the benefit of the filing date of U.S. Provisional Application No. 63/669,374, filed Jul. 10, 2024, the disclosure of which is hereby incorporated by reference herein in its entirety.

### BACKGROUND OF THE INVENTION

### Field of the Invention

The present invention relates to the field of providing battery charging to container handling equipment at container terminals using one or more mobile battery and charger(s).

### Description of Related Art

Examples of charging stations can be found in U.S. Pat. No. 11,338,687 and in U.S. Patent Application Publication Nos. 2021/0031638, 2023/0014378, 2023/0078886, and 2023/0253657. Examples of energy management systems can be found in US2023/0211697.

In addition to mobile batteries and chargers for charging multiple equipment units, this invention features a power station (or more than one) connected to the grid, for charging the mobile batteries and chargers and a facility energy management system. This energy management system communicates with the power station(s), mobile battery and charger(s), and equipment unit(s) and receives status of all of them. It is equipped with a control mechanism that automatically schedules the charging of mobile battery and charger units and various pieces of equipment. It determines and communicates to the power station(s) the maximum charging power available, based on overall terminal consumption and maximum demand capability of the system. This functionality prevents the container terminal from exceeding its available power capacity.

Additionally, the system coordinates and prioritizes the charging of multiple equipment units considering the corresponding scheduled activities, the state of charge and the reported charging availability time. It also maximizes energy usage and battery longevity.

### SUMMARY OF THE INVENTION

Embodiments of the invention include Aspect 1, which is a system for managing shipping equipment in a container terminal comprising: one or more mobile battery and charger; and equipment configured for loading, unloading, and/or moving shipping containers. In embodiments, provided are systems for managing shipping equipment in a container terminal comprising: one or more mobile battery and charger (e.g., configured to be moved from a primary location to one or more secondary locations); and equipment, such as one or more pieces of equipment, located in the one or more secondary locations, the equipment optionally configured for loading, unloading, and/or moving shipping containers. It is noted that in the context of this application the term equipment can be used interchangeably with the term piece(s) of equipment and the terms encompass equipment singularly or as a group, as well as multiple types of equipment and/or multiple pieces of the same type of equipment. In additional or alternative embodiments, the one or more battery and charger can comprise one or more mobile battery, one or more mobile charger, or combinations thereof.

Aspect 2 is the system of Aspect 1, wherein any of the equipment is powered by and/or comprises and/or is in operable communication with one or more equipment battery. In embodiments, any of the equipment and/or any one or more pieces of equipment are powered by one or more equipment battery, optionally configured to be charged by the one or more mobile battery and charger.

Aspect 3 is the system of Aspect 1 or 2, wherein the one or more mobile battery and charger is configured to be moved to a location near any of the equipment and/or one or more pieces of equipment.

Aspect 4 is the system of any of Aspects 1-3, wherein any of the equipment is configured to be charged by the one or more mobile battery and charger, such as by charging one or more equipment battery.

Aspect 5 is the system of any of Aspects 1-4, further comprising means to communicate to negotiate charging terms between the one or more mobile battery and charger and any of the equipment and/or pieces of equipment.

Aspect 6 is the system of any of Aspects 1-5, wherein the one or more mobile battery and charger is capable of delivering at least about 100 kW of power (e.g., to provide power to and/or to charge any equipment, including another mobile battery and charger). In embodiments, the one or more mobile battery and charger is configured (e.g., sized and/or rated) to deliver no less than about 100 KW of power to operate and/or charge appropriate equipment, such as equipment rated for use with such mobile battery and charger. In embodiments, the one or more mobile battery and charger is configured to deliver no less than about 10 kW of power, or about 20 kW of power, or about 30 kW of power, or 40 kW of power, or 50 kW of power, or 60 kW of power, or 70 kW of power, or 80 kW of power, or 90 kW of power, or 100 KW of power and/or at least about 100 KW, such as at least 200 kW, or at least 300 kW, or at least 500 kW, or about 1,000 kW.

Aspect 7 is the system of any of Aspects 1-6, wherein any of the equipment is a crane, such as a mobile crane or fixed crane capable of lifting and/or moving one or more shipping containers (e.g., a shipping container crane).

Aspect 8 is the system of any of Aspects 1-7, wherein one or more battery chargers of the mobile battery and charger is mounted on, in, under, within or outside of a housing of the one or more mobile battery and charger.

Aspect 9 is the system of Aspect 8, wherein one or more of the battery chargers of the mobile battery and charger are configured to be used simultaneously to charge any of the equipment, such as by charging one or more equipment battery.

Aspect 10 is the system of any of Aspects 1-9, further comprising a power station or a power supply, optionally wherein the power station or the power supply comprises an AC power source in operable connection with a fixed position (not mobile) battery charger and/or in operable connection with a mobile battery charger.

Aspect 11 is the system of any of Aspects 1-10, further comprising one or more connectors mounted on the one or more mobile battery and charger and/or any of the equipment, and/or mounted on any housing of the one or more mobile battery and charger or on any housing of any of the equipment, which connectors are configured to attach to a fixed position (not mobile) battery charger and/or configured to attach to a mobile battery charger. The connectors/ports for the inputs and/or outputs can be disposed on an interior and/or exterior of a housing and/or contained within a housing of the one or more mobile battery and charger and/or equipment. The connectors/ports for the inputs and/or outputs can be provided by way of electrical leads for connecting the one or more battery and charger directly or indirectly to the equipment, in, on or through any housing. For example, in any of FIGS. 1-7, the lines depicting connections represent one or more or multiple connections between components of the system at either side of the connection (input or output).

Aspect 12 is the system of any of Aspects 1-11, further comprising one or more connectors mounted on the one or more mobile battery and charger, such as on, in, under, within or outside of a housing of the mobile battery and charger.

Aspect 13 is the system of any of Aspects 1-12, further comprising one or more connectors mounted on any of the equipment, such as on, in, under, within or outside of a housing of the equipment.

Aspect 14 is the system of any of Aspects 1-13 comprising a plurality of mobile battery and charger units.

Aspect 15 is the system of any of Aspects 1-14, wherein the system is configured to operate under the supervision of an energy management system, optionally configured to prevent overloading of an AC power source during charging of one or more mobile battery and charger.

Aspect 16 is the system of any of Aspects 1-15, wherein the one or more mobile battery and charger has a voltage in the range of 400-1500 volts, such as in the range of no less than about 400 volts. In embodiments, the one or more battery and charger (which includes mobile battery and charger units) has a voltage in the range of no less than about 100 volts, no less than about 150 volts, no less than about 200 volts, no less than about 250 volts, no less than about 300 volts, no less than about 350 volts, no less than about 400 volts, no less than about 450 volts, no less than about 500 volts, no less than about 550 volts, no less than about 600 volts, no less than about 650 volts, no less than about 700 volts, no less than about 800 volts, no less than about 900 volts, no less than about 1,000 volts, no less than about 1,100 volts, no less than about 1,200 volts, no less than about 1,300 volts, no less than about 1,400 volts, no less than about 1,500 volts.

Aspect 17 is the system of any of Aspects 1-16, wherein the one or more mobile battery and charger comprises at least about 200 cells/string, such as in the range of no less than about 200 cells/string. In embodiments, the mobile battery and charger (or mobile battery and charger unit) comprises no less than about 50 cells/string, no less than about 100 cells/string, no less than about 150 cells/string, no less than about 200 cells/string, no less than about 300 cells/string, no less than about 400 cells/string.

Aspect 18 is the system of any of Aspects 1-17, wherein the one or more mobile battery and charger comprises about 10 strings, such as no less than about 10 strings. In embodiments, the mobile battery and charger (or mobile battery and charger unit) comprises no less than about 2 strings, no less than about 5 strings, no less than about 15 strings, or no less than about 20 strings.

Aspect 19 is the system of any of Aspects 1-18, wherein the one or more mobile battery and charger has an energy capacity of at least about 500 kWh, such as in the range of no less than about 500 kWh. In embodiments, the mobile battery and charger (or mobile battery and charger unit) has an energy capacity of at least about 200 kWh, at least about 300 kWh, at least about 400 kWh, at least about 500 kWh, at least about 1 MWh, at least about 1.5 MWh, at least about 2 MWh, at least about 2.5 MWh, or at least about 5 MWh.

Aspect 20 is the system of any of Aspects 1-19, wherein any of the equipment comprises and/or is in operable communication with and/or is powered by one or more equipment battery with a voltage in the range of about 400-1500 volts, such as in the range of no less than about 400-1500 volts. In embodiments, one or more of the equipment batteries has a voltage of no less than 200 volts, or no less than 300 volts, or no less than 450 volts, or no less than 500 volts, or no less than 600 volts, or no less than 750 volts, or no less than 1,000 volts, or no less than 1,200 volts, or no less than 1,300 volts, or no less than 1,500 volts.

Aspect 21 is the system of any of Aspects 1-20, wherein any of the equipment comprises and/or is in operable communication with and/or is powered by one or more equipment battery comprising at least about 160 cells/string, such as in the range of no less than about 160 cells/string. In embodiments, one or more of the equipment batteries comprises no less than about 50 cells/string, or no less than 75 cells/string, or no less than 100 cells/string, or no less than 200 cells/string, or no less than 250 cells/string, or no less than 300 cells/string, or no less than 400 cells/string.

Aspect 22 is the system of any of Aspects 1-21, wherein any of the equipment comprises and/or is in operable communication with and/or is powered by one or more equipment battery with a capacity of up to or about 154 kWh, such as in the range of no less than about 154 kWh. In embodiments, one or more of the equipment batteries has a capacity of no less than about 50 kWh, or no less than about 75 kWh, or no less than about 90 kWh, or no less than about 100 kWh, or no less than 120 kWh, or no less than 160 kWh, or no less than 200 kWh, or no less than 250 kWh, or no less than 300 kWh, or no less than 350 kWh.

Aspect 23 is the system of any of Aspects 1-22, wherein one or more of the power station, the power supply, the mobile battery and charger, and/or equipment or piece(s) of equipment are configured to report one or more status to an energy management system.

Aspect 24 is the system of any of Aspects 1-23, further comprising an energy management system configured to receive and/or obtain one or more status of the power station, the power supply, the mobile battery and charger, and/or the equipment.

Aspect 25 is the system of Aspect 23 or 24, wherein the status is a state of charge (SoC), which can be expressed as a percent charge for the mobile battery and charger and/or the equipment and/or the equipment battery.

Aspect 26 is the system of any of Aspects 23-25, wherein the status comprises energy usage data for the power station, the power supply, one or more of the pieces of equipment and/or the mobile battery and charger.

Aspect 27 is the system of any of Aspects 23-26, wherein the energy management system is configured to automatically schedule charging of the mobile battery and charger and/or the equipment and/or equipment battery in a manner to maximize energy usage and/or battery longevity or health.

Aspect 28 is a system for managing shipping equipment in a container terminal comprising: one or more mobile battery and charger, wherein the one or more mobile battery and charger is configured to be moved to a location near equipment to be charged; equipment configured for loading, unloading, and/or moving shipping containers, wherein the equipment: is powered by one or more equipment battery; and is configured to be charged by the one or more mobile battery and charger; and operable communication to negotiate charging terms between the one or more mobile battery and charger and any of the equipment.

Aspect 29 is a system for managing shipping equipment in a container terminal comprising: the one or more mobile battery and charger, wherein the one or more mobile battery and charger is capable of delivering at least 100 KW of power (such as no less than 100 kW); and equipment configured for loading, unloading, and/or moving shipping containers, wherein any of the equipment is a crane, such as a mobile or fixed crane capable of lifting shipping containers.

Aspect 30 is a system for managing shipping equipment in a container terminal comprising: a plurality of mobile battery and charger units configured to be moved to a location near equipment; equipment configured for loading, unloading, and/or moving shipping containers; and in operable connection with a supply of equipment coolant.

Aspect 31 is a system for managing shipping equipment in a container terminal comprising: a plurality of mobile battery and charger units configured to be moved to a location near equipment; equipment configured for loading, unloading, and/or moving shipping containers, optionally wherein the equipment comprises one or more equipment battery with a capacity of up to about 154 kWh (such as no less than 154 kWh); and an energy management system, optionally configured to prevent overloading of an AC power source during charging.

Aspect 32 is a facility energy management system comprising: a plurality of mobile battery and charger units configured to be moved to a location near equipment; equipment, such as a crane capable of lifting shipping containers; an energy source; and a control system in operable communication with the equipment and with the plurality of mobile battery and charger units, which control system is configured to control overall energy demand on the energy source by one or more or all of: (i) receiving a signal from one or more of the equipment indicating a need for charging of the equipment, and/or (ii) sending a signal to the one or more mobile battery and charger unit(s) indicating which equipment to charge and optionally a specified time to charge the equipment, and/or (iii) receiving a signal from the one or more mobile battery and charger unit(s) indicating a need for charging of one or more of the mobile battery and charger unit(s) and (iv) sending a signal to the one or more mobile battery and charger unit(s) indicating the energy source is available for charging the mobile battery and charger unit(s), optionally at a specified time.

Aspect 33 is the system of Aspect 32, wherein the one or more mobile battery and charger unit(s) and the equipment are disposed at a shipping container terminal.

Aspect 34 is the system of Aspect 32 or 33, wherein the signal to the one or more mobile battery and charger unit(s) indicating which equipment to charge prioritizes the order in which to charge multiple equipment, and optionally a specified time to charge each equipment.

### BRIEF DESCRIPTION OF THE DRAWINGS

The accompanying drawings illustrate certain aspects of implementations of the present disclosure and should not be construed as limiting. Together with the written description, the drawings serve to explain certain principles of the disclosure.

FIG. 1 is a diagram for a system for charging one or more container handling equipment using one or more mobile battery and charger(s), according to embodiments of the invention.

FIG. 2 is a diagram for a container handling equipment according to a embodiments of the invention.

FIG. 3 is a diagram for a mobile battery and charger according to embodiments of the invention.

FIG. 4 is a diagram for a charging station according to embodiments of the invention.

FIG. 5 is a diagram of the connection between a charger power station and a mobile battery and charger according to embodiments of the invention.

FIG. 6 is a diagram of the connection between a mobile battery and charger and container handling equipment according to embodiments of the invention.

FIG. 7 is a diagram of the communications between a facility energy management system, a charging station control, a mobile battery and charger control, and a container handling equipment control according to embodiments of the invention.

FIG. 8 is a flow chart showing a representative process of embodiments of the invention and interaction of the facility energy management system with the mobile battery and charger control to initiate and enable charging of container handling equipment by one or more mobile battery and charger, determine equipment status of the container handling equipment and/or mobile battery and charger, dispatch the mobile battery and charger for maintenance, re-charging of the mobile battery and charger and/or charging of equipment.

### DETAILED DESCRIPTION OF VARIOUS EMBODIMENTS OF THE INVENTION

With an increase in desire to reduce or eliminate carbon emissions, there is a need for zero emission container handling equipment. This electric container handling equipment requires batteries instead of traditional diesel generator power, and the batteries must be periodically recharged.

One challenge for container terminals with larger numbers of fully electric container handling equipment is recharging the equipment batteries without disrupting operation. One traditional solution involves fixed charging stations and requires the equipment to move to the charging stations. This is sometimes physically impractical, results in a decrease in productivity of the equipment, and disrupts overall terminal operation. Another solution is to bring electrical service directly to the equipment via catenary or rail systems. This solution requires substantial infrastructure to be installed within the terminal and restricts the mobility of the equipment.

In contrast, the present invention provides systems and methods for charging the batteries of electric container handling equipment at container terminals with one or more mobile battery and charger(s) that can be transported close to the container handling equipment. In embodiments, the mobile battery and charger(s) are recharged at one or more charging station(s).

In embodiments, the present invention includes a mobile battery and charger(s) configured for energy storage and capable of moving to a location where a container handling equipment is operating. This avoids time lost while the equipment travels to a remote charging station. Depending on the energy storage capability, one or more or each mobile battery and charger can recharge several pieces of container handling equipment before the mobile battery and charger needs to travel to the charging station. The mobile battery and charger can be transported to and from the charging station and/or to and from the vicinity of container handling equipment in any manner. In embodiments, one or more mobile battery and charger are disposed on a trailer and transported by a truck to various locations at the site. Multiple trucks and trailers can be used to transport multiple mobile battery and charger units. Since the container handling equipment does not need to travel to the charging stations, the charging stations can be strategically located to avoid congestion at the container terminal.

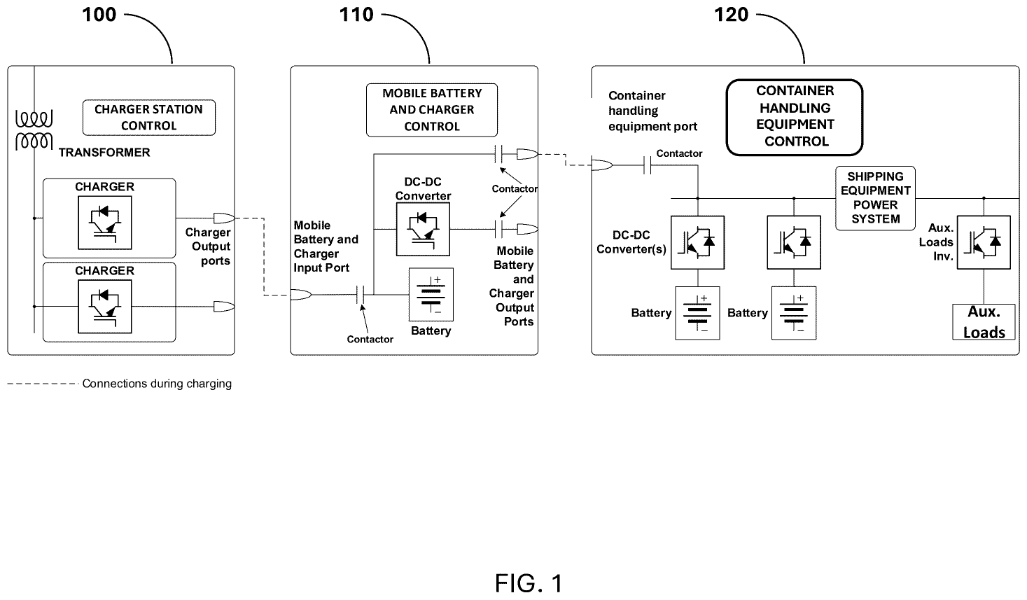

FIG. 1 shows a charging station 100 capable of operable connection with one or more mobile battery and charger(s) 110, which are configured to charge one or more pieces of equipment, such as electric container handling equipment 120. The container handling equipment port, connected to a common DC bus, is used to transfer energy from the mobile battery and charger(s) 110 to recharge the container handling equipment 120 batteries.

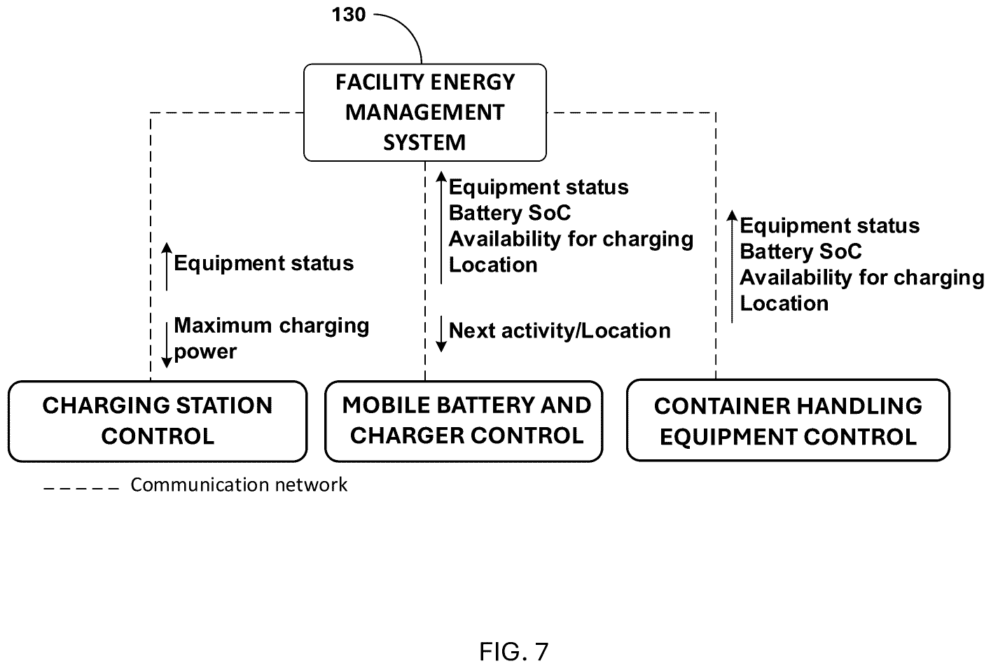

Means to recharge the mobile battery and charger(s) 110 (such as mobile battery and charger input ports) are located such that they can conveniently connect to a sufficient energy source. In embodiments, the mobile battery and charger(s) 110 in the charging station 100 would be under the supervision of a facility energy management system 130 (FIG. 7) intended to control the overall energy demand of the facility on the energy source. In embodiments, such as due to an expected increase in total power demand, the facility energy management system 130 is capable of controlling the maximum charging power in order to maintain the overall system power demand within the limits of the power system or utility requirements.

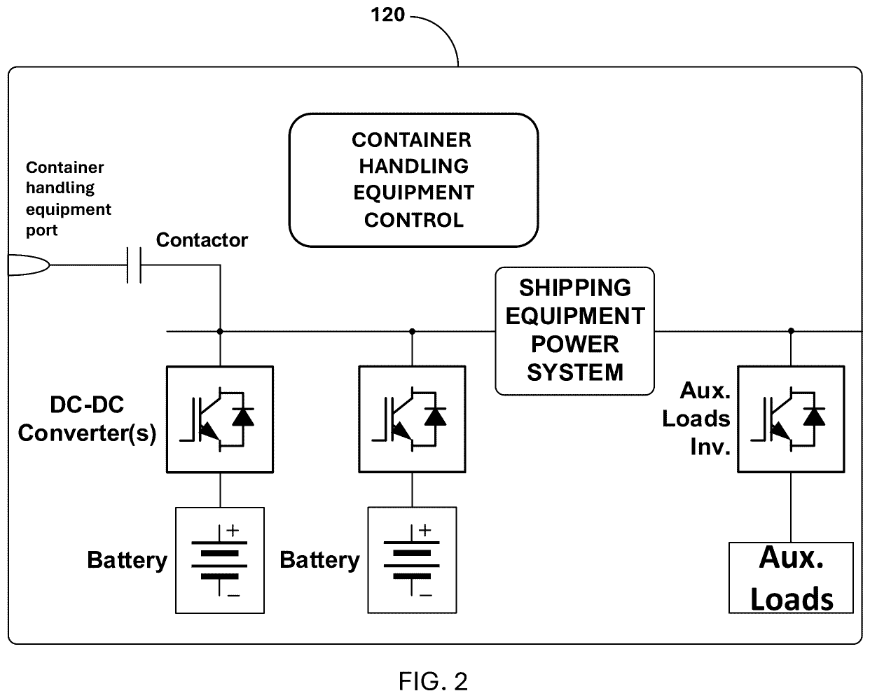

FIG. 2 shows components of the container handling equipment 120. The electric container handling equipment 120 includes one or more inverters to control the speed of the different motions and to feed the auxiliary loads with a fixed voltage and frequency. The inverters are connected to a common energy distribution means, such as a DC bus. In embodiments, one or more DC bus can be present. In addition, one or more converters (such as one or more DC-DC converter) are used to move energy from batteries to the common bus when one or more motions and/or one or more auxiliary loads are consuming energy, or from the common bus to the batteries when there is energy regeneration, such as may be harvested in response to a hoisting mechanism lowering a load. In embodiments, a container handling equipment control manages the motions of the container handling equipment 120, the battery system of the container handling equipment 120, and recharging of the container handling equipment, such as the recharging sequence. In embodiments, the container handling equipment control (or the container handling equipment 120) can comprise multiple batteries, multiple DC-DC converters, and/or multiple inverters, whether in operable connection by way of a single common DC bus or separate DC buses.

The container handling equipment 120 comprises at least one container handling equipment port configured to operably connect with a mobile battery and charger output port, such as 1, 2, 3, 4, or more ports. In embodiments, the container handling equipment 120 is configured to connect with and receive energy from two or more mobile battery and chargers 110 simultaneously. In embodiments, the container handling equipment 120 is configured to connect with and receive energy from one or more mobile battery and chargers 110, such as a single mobile battery and charger 110.

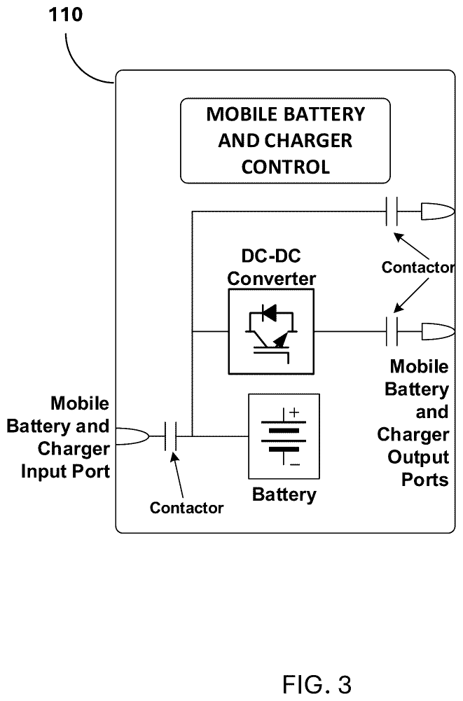

FIG. 3 is an electrical diagram of a mobile battery and charger 110. In embodiments, the mobile battery and charger 110 has the capacity to recharge one or more container handing equipment 120 via connection via one or more mobile battery and charger output ports.

In embodiments, the mobile battery and charger 110 has the ability to store up to 4 MWh, such as up to about 200 kWh, 250 kWh, 300 kWh, 350 kWh, 400 kWh, 500 kWh, 600 kWh, 700 kWh, 800 kWh, 900 kWh, 1 MWh, 1.2 MWh, 1.3 MWh, 1.4 MWh, 1.5 MWh, 1.6 MWh, 1.7 MWh, 1.8 MWh, 1.9 MWh, 2 MWh, 2.2 MWh, 2.4 MWh, 2.6 MWh, 2.8 MWh, 3 MWh, 3.2 MWh, 3.4 MWh, 3.6 MWh, or 3.8 MWh, or at least about 200 kWh, at least about 300 kWh, at least about 400 kWh, at least about 500 kWh, at least about 1 MWh, at least about 1.5 MWh, at least about 2 MWh, at least about 2.5 MWh, or at least about 5 MWh.

In embodiments, one or more of the mobile battery and charger(s) 110 has a voltage in the range of about 400-1500 volts, such as about 425 V, 450 V, 475 V, 500 V, 525 V, 550 V, 575 V, 600 V, 625 V, 650 V, 675 V, 700 V, 750 V, 800 V, 850 V, 900 V, 950 V, 1 kV, 1.1 kV, 1.2 kV, 1.3 kV, or 1.4 kV.

The mobile battery and charger 110 comprises at least one input port for recharging, such as through connection at a charging station 100.

The mobile battery and charger 110 further comprises a charger connected to and/or in operable communication with one or more mobile battery and charger output ports.

In embodiments, one or more contactor(s) are present to isolate the one or more batteries, such as in the case of a fault or alarm condition.

In embodiments, the mobile battery and charger 110 includes one or more output ports that are directly connected to the battery, one or more output ports that are connected to the battery through DC-DC converter(s), or both. The mobile battery and charger 110 can comprise a contactor associated with each input port and output port, such that there is a contactor between the battery and the input port and/or between the battery and the output port. For example, DC-DC converters can be used for cases where the mobile battery and charger 110 must provide voltage and current regulation for recharging the container handling equipment 120.

In embodiments, the mobile battery and charger 110 comprises a mobile battery and charger control comprising control electronics, circuit protection, disconnection means, and/or software. In embodiments, the software includes a battery management system and facilitates communication with one or more of: the corresponding charging stations, the container handling equipment's controls, and/or the facility energy management system 130.

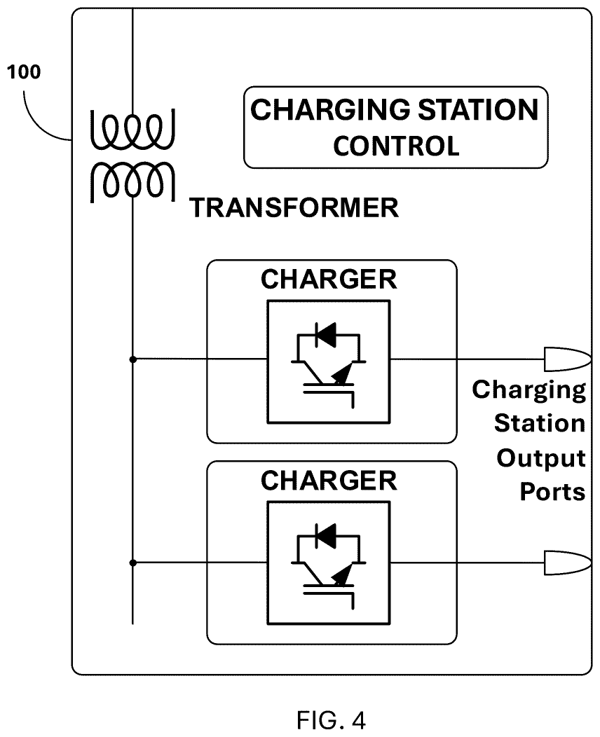

FIG. 4 is an electrical diagram showing a charging station 100. The charging station 100 comprises a transformer to adapt voltage and provide isolation between the grid and at least one charger, such as 2, 3, 4, 5, 6, or more chargers. The chargers rectify the AC incoming voltage to DC and have the capability of regulating the output current and voltage. Each charger is connected to one or more charging station output ports (or charger output ports), such as 2, 3, 4, 5, 10, or more charging station output ports (or charger output ports).

The charging station control facilitates the communication between the chargers and mobile battery and charger 110 and monitors and controls the total charging station consumption by adjusting the power output of the chargers.

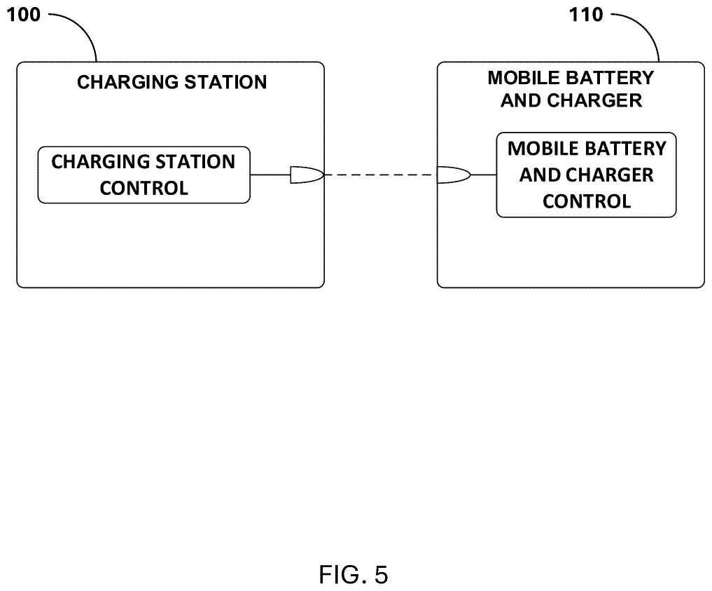

FIG. 5 shows the connection between a charging station 100 and a mobile battery and charger 110 through the charging station control and the mobile battery and charger control. Common connectors used can include combined charging system connectors (CCS), Megawatt Charging System connectors (MCS), and North American Charging system connectors (NACS). These controls communicate to negotiate the optimum voltage and current the chargers will provide to the mobile battery and charger. Standard communication protocols used for this negotiation are described in IEC 61851, DIN 70121, and IEC 15118 (which references are hereby incorporated by reference herein in their entireties). The final voltage and currents depend on the battery state of charge (SoC), battery temperature, and the maximum available power for the charging power station.

In embodiments of the invention, when the battery state of charge (SoC) is low, the charger can be configured to operate in a constant current mode, defined by the battery charging rate and the charger capability. Once the battery reaches a certain voltage, the charger can be configured to switch to a constant voltage mode, and the current will decrease as the SoC increases. In embodiments, a user can select constant voltage mode or constant current mode. In embodiments, the charging station 100 selects and/or changes between a constant voltage mode and a constant current mode based on set parameters, such as a set state of charge threshold. In embodiments, the charging station 100 changes from the constant current mode to the constant voltage mode when the state of charge reaches approximately 50% or higher. For example, the charging station 100 can change from constant current mode to constant voltage mode at any state of charge threshold desired or specified, such as 50% or higher. Alternatively or in addition, the charging station 100 can change from constant current mode to constant voltage mode once the battery reaches a certain voltage, such as at 75%, 80%, 90%, 95% or 99%.

In embodiments, battery temperature and/or charging cable temperature are considered to avoid an overtemperature condition. The charging station 100 has the capability to discontinue charging or reduce the charging rate based on one or more upstream limitation provided to the station by a communication link. In embodiments, a battery (or charging cable) temperature range or threshold is set by the user or the charging station 100, and once the threshold temperature is reached, the charging station 100 will instruct the mobile battery and charger 110 to reduce the charging rate.

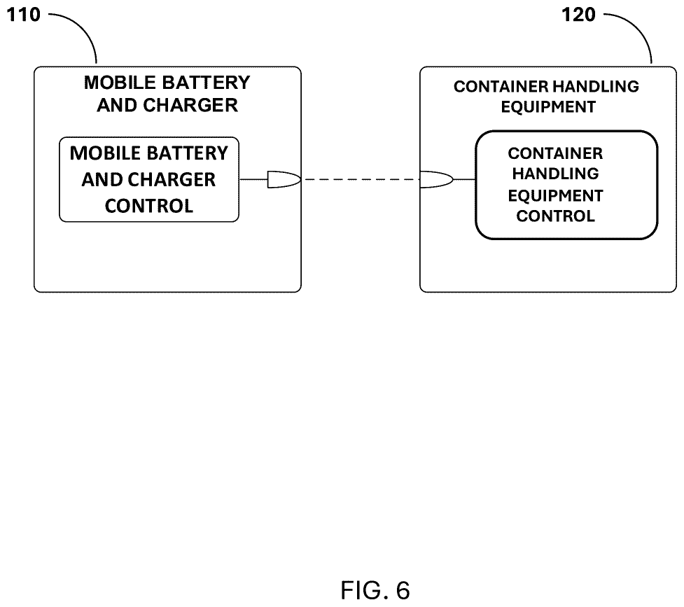

FIG. 6 shows the connection between the mobile battery and charger 110 and the container handling equipment 120 through the mobile battery and charger control and the container handling equipment control. Common connectors used can include combined charging system connectors (CCS), Megawatt Charging System connectors (MCS), and North American Charging system connectors (NACS). These controls communicate to negotiate the optimum voltage and current that the chargers and the container handling equipment DC-DC converters will provide to the container handling equipment battery. Example protocols for the negotiation are described in IEC 61851, DIN 70121, and IEC 15118. The voltage and current depend on the container handling equipment battery's design, state of charge and temperature. In embodiments, the voltage is in the range of about 375 V-1500 volts, such as about 400 V, 425 V, 450 V, 475 V, 500 V, 525 V, 550 V, 575 V, 600 V, 625 V, 650 V, 675 V, 700 V, 750 V, 800 V, 850 V, 900 V, 950 V, 1 kV, 1.1 kV, 1.2 kV, 1.3 kV, or 1.4 kV.

FIG. 7 shows a facility energy management system 130 communication scheme with individual controls for each of the components of the system: a charging station control (or charger station control), a mobile battery and charger control, and a container handling equipment control.

In embodiments, the facility energy management system 130 controls and monitors all of the charging for the equipment and the mobile battery and charger batteries. Based on the state of charge of the mobile battery and charger and the shipping equipment batteries and the charging station available power, the energy management system will instruct the corresponding charging activities.

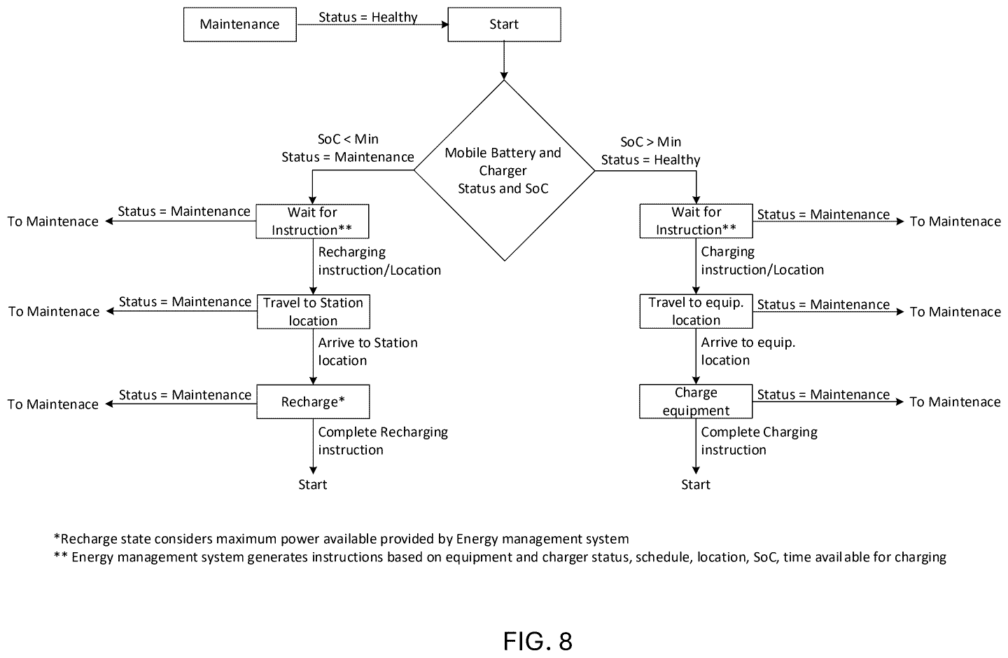

FIG. 8 is a flow chart showing a representative process of embodiments of the invention and interaction of the facility energy management system 130 with the mobile battery and charger control to initiate and enable charging of container handling equipment by one or more mobile battery and charger, providing location of the container handling equipment to be recharged, determine equipment status of the container handling equipment and/or mobile battery and charger, dispatch the mobile battery and charger for maintenance, re-charging of the mobile battery and charger and/or charging of equipment.

In embodiments, the facility energy management system 130 is configured to monitor one or more conditions of the mobile battery and charger(s), such as the State of Charge (SoC) and/or the “health” status of the mobile battery and charger(s). The SOC can be expressed as a percentage value that is compared with a minimum threshold value. The “health” status of the mobile battery and charger can be either healthy or unhealthy. The “health” status is related to the fault conditions of the batteries and other components inside this equipment, such as an open fuse, overtemperature, over or under voltages in a battery, etc.

As shown in FIG. 8, when the SOC of a mobile battery and charger encroaches on, achieves or falls below a threshold, the facility energy management system 130 can send instructions to the mobile battery and charger to return to the charging station for the purpose of re-charging. In response, the mobile battery and charger is transported (e.g., by way of truck and trailer, manually or autonomously) to the charging station. The input port of the mobile battery and charger is connected to the output port of a charger or charging equipment of the charging/charger station and the mobile battery and charger is charged. Once the re-charging is complete, the facility energy management system 130 is informed and the mobile battery and charger receives instructions for container handler equipment to be charged and the location of the equipment and the optimum path. The mobile battery and charger is transported to the container handler location, the output port of the mobile battery and charger is connected with the input port of the container handling equipment, the charging instructions are completed by the mobile battery and charger, and the facility energy management system 130 is informed of the status of the container handling equipment. The facility energy management system 130 sends additional instructions to the mobile battery and charger for charging additional container handling equipment unit(s) and the transporting/charging process can be repeated until the “health” status changes to “unhealthy” or until the SoC status changes, and the mobile battery and charger either needs maintenance to correct an “unhealthy” condition and/or needs re-charging. When the status of the mobile battery and charger is “unhealthy”, the status is sent to the facility energy management system 130 and in response instructions are sent to the mobile battery and charger to obtain maintenance and/or to be transported to a location for maintenance. Upon completion of the maintenance, a “healthy” status of the mobile battery and charger is sent to the facility energy management system 130 and in return instructions are sent to the mobile battery and charger for charging container handling equipment, and the process is repeated.

In embodiments, one or more methods or method steps (e.g., one or more steps performed by the facility energy management system 130) described herein can be embodied in software or set of computer-executable instructions capable of being run on a computing device or devices. The computing device or devices can include one or more processor (CPU) and a computer memory. The computer memory can be or include a non-transitory computer storage media such as RAM which stores the set of computer-executable (also known herein as computer readable) instructions (software) for instructing the processor(s) to carry out any of the methods or routines described in this disclosure. As used in the context of this disclosure, a non-transitory computer-readable medium (or media) can include any kind of computer memory, including magnetic storage media, optical storage media, nonvolatile memory storage media, and volatile memory. Non-limiting examples of non-transitory computer-readable storage media include magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM. The computer-readable instructions can be programmed in any suitable programming language, including JavaScript, C, C#, C++, Java, Python, Perl, Ruby, Swift, Visual Basic, and Objective C. Embodiments of the invention also include a non-transitory computer readable storage medium having any of the computer-executable instructions described herein.

A skilled artisan will further appreciate, in light of this disclosure, how the invention can be implemented, in addition to software and hardware, using one or more firmware. As such, embodiments of the invention can be implemented in a system which includes any combination of software, hardware, or firmware. In the context of this specification, the term “firmware” can include any software programmed onto the computing device, such as a device's nonvolatile memory. Thus, systems of the invention can also include, alternatively or in addition to the computer-executable instructions, various firmware modules configured to perform the algorithms of the invention.

According to embodiments, the computing device or devices can include a mainframe computer, web server, database server, desktop computer, laptop, tablet, netbook, notebook, personal digital assistant (PDA), gaming console, e-reader, smartphone, or smartwatch, which may include features such as a processor, memory, hard drive, graphics processing unit (GPU), and input/output devices such as display, keyboard, and mouse or trackpad (depending on the device). Embodiments can also provide a graphical user interface made available on one or more computers.

Additional embodiments of the invention can include a networked computer system for carrying out one or more methods of the invention. The computer system can include one or more computing devices which can include a processor for executing computer-executable instructions, one or more databases, a user interface, and a set of instructions (e.g. software) for carrying out one or more methods of the invention. According to other embodiments, the computing device or devices can be connected to a network through any suitable network protocol such as IP, TCP/IP, UDP, or ICMP, such as in a client-server configuration and one or more database servers. The network can use any suitable network protocol and can be any suitable wired or wireless network including any local area network, wide area network, Internet network, telecommunications network, Wi-Fi enabled network, or Bluetooth enabled network

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Any of the methods disclosed herein can be used with any of the compositions disclosed herein or with any other compositions. Likewise, any of the disclosed compositions can be used with any of the methods disclosed herein or with any other methods. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A system for managing shipping equipment in a container terminal comprising:
one or more mobile battery and charger; and
equipment configured for loading, unloading, and/or moving shipping containers.

2. The system of claim 1, wherein any of the equipment or any piece of the equipment is powered by, comprises and/or is in operable communication with one or more equipment battery.

3. The system of claim 1, further comprising means to communicate to negotiate charging terms between the one or more mobile battery and charger and any of the equipment and/or any piece of equipment.

4. The system of claim 1, wherein the one or more mobile battery and charger is capable of delivering at least 100 kW of power.

5. The system of claim 1, wherein the equipment comprises a crane.

6. The system of claim 1, wherein two or more of the mobile battery and chargers are configured to be used simultaneously to charge one or more pieces of equipment.

7. The system of claim 1, further comprising a power station or a power supply, comprising an AC power source in operable connection with at least one battery charger.

8. The system of claim 1 in operable connection with a supply of equipment coolant.

9. The system of claim 1, wherein one or more pieces of the equipment comprise one or more equipment batteries that do not require a liquid cooling means.

10. The system of claim 1, wherein one or more of the mobile battery and chargers:
has a voltage in the range of 400-1500 volts; and/or
comprises no less than about 200 cells/string; and/or
has an energy capacity of at least about 500 kWh.

11. The system of claim 2, wherein the one or more equipment battery:
has a voltage in the range of 400-1500 volts; and/or
comprises no less than about 160 cells/string; and/or
has a capacity in the range of about 50-250 kWh.

12. The system of claim 1, further comprising an energy management system configured to prevent power source overload.

13. The system of claim 12, wherein a power station, a power supply, the one or more mobile battery and charger, and/or one or more pieces of the equipment are configured to report one or more status to an energy management system.

14. The system of claim 13, wherein the status comprises a state of charge for the one or more mobile battery and charger and/or one or more of the pieces of equipment.

15. The system of claim 13, wherein the status comprises energy usage data for the power station, the power supply, one or more of the pieces of equipment and/or the one or more mobile battery and charger.

16. The system of claim 13, wherein the energy management system is configured to automatically schedule charging of the one or more mobile battery and charger and/or one or more of the pieces of equipment in a manner to not exceed the power available at a container terminal.

17. A facility energy management system comprising:
one or more pieces of equipment;
a plurality of mobile battery and charger units configured to be moved to one or more locations near the one or more pieces of equipment;
an energy source; and
a control system in operable communication with the one or more pieces of equipment and with the plurality of mobile battery and charger units and configured to control energy demand on the energy source by:
(i) receiving a first signal from a first piece of equipment of the one or more pieces of equipment, wherein the first signal indicates a need for charging of the first piece of equipment;
(ii) sending a second signal to a first mobile battery and charger unit of the plurality mobile battery and charger units indicating the first piece of equipment is to be charged.

18. The system of claim 17, wherein the control system is further configured to:
(iii) receive a third signal from the first mobile battery and charger unit indicating a need for charging of the first mobile battery and charger; and
(iv) send a fourth signal to the first mobile battery and charger unit indicating the energy source is available for charging the first mobile battery and charger unit.

19. The system of claim 17, wherein the plurality of mobile battery and charger units and the one or more pieces of equipment are disposed at a shipping container terminal.

20. The system of claim 17, wherein the second signal indicates multiple pieces of equipment to be charged and prioritizes the order in which to charge the multiple pieces of equipment.
